(19) United States
(12) Patent Application Publication
(10) Pub. No.: US 2009/0276807 A1
(43) Pub. Date: Nov. 5, 2009

(54) Facilitating indication of metadata availbility within user accessible content

(75) Inventor: Robert Robotham, Ottawa (CA)

Correspondence Address: ALCATEL-LUCENT, C/O GALASSO & ASSOCIATES, LP, P. O. BOX 26503, AUSTIN, TX, 78755-0503, US

(73) Assignee: ALCATEL LUCENT

(21) Appl. No.: 12/150,797

(22) Filed: May 1, 2008

(51) Int. Cl. H04N 5/445; H04N 7/173

(52) U.S. Cl. 725/40; 725/115; 725/131

(57) ABSTRACT

In one embodiment of the present invention, a method for facilitating association of user accessible content and supplemental information that is at least one of audibly and visually outputted by a user terminal comprises a plurality of operations. An operation is performed for maintaining a data structure that associates supplemental information relating to such user accessible content with timeframe information corresponding to the supplemental information. Prior to a location within said user accessible content where content corresponding to the supplemental information is contained being outputted via the user terminal, an operation is performed for receiving a timeframe information query corresponding to said user accessible content from the user terminal. An operation is performed for transmitting the timeframe information for reception by the user terminal in response to receiving the timeframe information query and prior to the location within said user accessible content where content corresponding to the supplemental information is contained being outputted by the user terminal.

### CROSS REFERENCE TO RELATED APPLICATIONS

This patent application is a continuation-in-part application of co-pending United States Provisional Patent Application having Ser. No. ______ filed ______ entitled “AN APPROACH FOR ASSOCIATING ADVERTISING SUPPLEMENTAL INFORMATION WITH VIDEO PROGRAMMING”, and having a common applicant herewith, which is incorporated herein in its entirety by reference.

### FIELD OF THE DISCLOSURE

The disclosures made herein relate generally to communication networks and, more particularly, to ways of associating supplemental information with content (e.g., audio and/or video or objects or persons).

### BACKGROUND

Television commercial messages (commercials, advertisements or ads), which are examples of program content accessible by a user via a user terminal, have become a common way to advertise products, manufacturers, services, politicians, charities, etc. on behalf of their sponsors. In the traditional video advertising model, the services providers deliver entertainment content and ads to the consumers (viewers) with a view to induce the consumers that watch the entertainment content to buy the advertised products/services. Typically, the service provider may charge the consumers for the entertainment content delivery but receives most revenue from the product/service promoters in exchange for delivering ads with the entertainment content.

Certain television commercials which are informative, educational or entertaining may be worth retaining for future viewing and exploring. For example, certain television commercials may contain information of particular relevance to a certain user, such as sales data for a product/service of interest, historically significant political messages, or may be just entertaining and deserve re-viewing. Other commercials, which may be bothersome and/or uninteresting to a viewer, would most probably be ignored. In this case, the consumer changes the channel, walks away during the commercial breaks, or turns to less advertising-dependent entertainment forms such as premium channels that do not include commercials. In response to this behavior, technology advances in the area of video recording now include functionality for avoiding commercials, such as a commercial skip feature that causes a recorder to move forward 30 seconds during playback, or basic commercial detection during recording.

Furthermore, recent technological advancements, such as Internet, have caused an increase in possible entertainment outlets. As a result, it became more difficult for the TV services providers and advertisers to increase the number of consumers their ads reach; also, it became increasingly difficult to guarantee that consumers will watch, hear, read, or otherwise absorb or become exposed to the ads within the entertainment content. This trend has led to lower advertising fees and lower profits.

In addition, the traditional video advertising model does not provide the consumers with enough information about the products of interest. Just seeing a short clip with a product/service in the middle of a TV program does not necessarily provide enough information to generate a sale by them. A fraction of the audience who could be potential customers may not know how to perform a successful Internet search, and a further fraction may not be motivated enough to perform such a search or use other mechanism to gain more information. Furthermore, if an Internet search is performed, it may return results for competitor's products. And the presence of a product in a program does not necessarily mean that additional information is readily available—repeated unsuccessful searches due to wrong key words, or misspelling of the product/company name will discourage further attempts. Still further, television advertising does not present the information in a helpful, practical or personalized way, in other words it is not inherently selective. Although an advertisement can be placed in a program, which has been made for an audience with somewhat specific market characteristics, it is in generally difficult to target traditional television advertising.

The proportion of the audience, which is thought to be genuinely interested in an advertisement, varies by product category, but normally ranges from 20-40%. Therefore, the advertisement viewed by the other 60-80% of the audience, which are not prime candidates, represents a large amount of wasted spending by the advertiser.

Targeted advertising business model has emerged as a result, whereby the advertisers focus on delivering specific, personalized commercials to the consumers that meet a demographic profile based on estimating audience characterization, or profiling. Attempts to target advertising accurately towards the consumers are based on fine-grained demographics for the region or by tracking viewing patterns, or a combination. Characterization of the audience facilitates a promoter pricing advertisement delivery at a level that accurately reflects value. However, audience characterization provides only estimates of which ads certain groups of consumers will accept; greater accuracy would likely require the cooperation of the viewer. But, most viewers are not eager to volunteer more personal information and are suspicious when information on their behavior is collected without their active participation. As a result accuracy is likely to remain limited and consumers of a targeted group may ignore or avoid the ads targeted for them, and not receive ads that might interest them.

Another conventional method for product/services video promotion is broadcasting this type of information over a “shopping channel”. However, conventional systems for organizing video content on these channels are not well tailored to emulating the shopping experience; while purchasing goods through a conventional communication network offers the luxury of shopping from home, the benefits of traditional shopping malls continues to draw shoppers.

Still another approach taken in broadcast video is product placement. In this method, products are visible during the program (e.g. a character drinking a particular soft drink or using a particular brand of computer). This requires that the advertised products/services have distinctive packaging and easily identifiable characteristics. Also, this method requires the advertisers to balance between the product being noticeable and being obviously pushed. And that balance may vary between viewers. That is, while some viewers may not notice the product allegedly being advertised, others could be annoyed by the placement. And there is a limit on the number of products that can be presented simultaneously, on the order of one. This approach is limited to products that already enjoy customer recognition, or else requires explicit mention, which may be suitable for certain programming types but otherwise tends to appear artificial. As well, without explicitly being part of the program, the amount of information available on a product is extremely limited.

It also known to embed advertising within the programming. This is dominant in the broadcast of sporting events, in which participants may use clothing and/or gear with advertising on it and the event may be surrounded by billboards showing advertising. Advertising may also be superimposed on the programming to appear part of the event field. This type of advertising tends to have similar limitations as described above, in terms of not being able to be customized, requiring viewer recognition and being limited in the amount of information that can be conveyed. The ability to superimpose images of advertisements onto otherwise live feeds has emerged allowing customization, though the other limitations remain.

Closed-captioning (CC) and alternate audio tracks are not particularly suited to advertising. Each CC or audio channel only provides a single stream of information, and provides “real time” information, with the program (i.e. the program needs to be running with the appropriate CC and/or audio channel selected). The amount of information provided in this scenario is limited to text or audio information, and is also limited by the amount of time available, i.e. during a half hour program each CC or alternate audio channel can only provide half an hour worth of product information. Furthermore, there is a practical limit on the number of CC and alternate audio channels available (at least for broadcast video programs). Advertising is present in closed captioning for the companies that sponsor the creation of the closed captioning of the program.

As a general note, independent of technology to bypass advertisements, people tend to develop resistance to advertising that is not relevant to them, which results in their “tuning out” advertising of any format. Novel formats of advertising may grab their attention for a period of time, however, consumers eventually become jaded and the effectiveness fades.

This effect does not apply if the viewer/consumer is actively looking for information on a particular product/subject. A need exists for enhancing viewer ability for selection and use of commercials, by designing a cost-effective, entertaining, rewarding, and effective way of enticing consumers to become immersed in on-demand ads to a level that stimulates a product purchase or achieves brand recognition.

There are forms of interactive video (including advertising) available from at least one service provider. The implementation used limits the interactivity points to what is implemented during content creation. This greatly limits the flexibility. The current implementations require the insertion of “metatags” (i.e., metadata) into the media stream(s) to allow the identification of potential points of interactivity. Metadata is defined herein to be information that describes the content, quality, condition, origin, and other characteristics of data or other pieces of information (i.e., information about information). This needs to occur at the time of content generation/encoding, changing or adding new points requires re-encoding. The production of interactive programming is appreciably more complex than conventional production—and cannot be separated.

To summarize, some commercials may have an entertainment and educational value to some consumers, and in some instances, the consumers look forward to certain advertisement campaigns from specific manufacturers. However it is difficult or impossible to provide all information on a product that any potential customer may be interested in within a reasonable size of ad. The longer the ad, the greater the cost to the advertiser, the fewer number of ads that can be sold and the greater likelihood that some viewers will be annoyed. Obtaining the additional information that a customer may want before making a purchase requires effort that viewers may not take. Depending on the mechanism by which additional information is obtained, the potential customer may be exposed to competitive products and the advertisement could result in a sale for a competitor. The current methods and systems of pushing advertising at consumers are susceptible to viewer fatigue or outright counter-measures. Specifically pulling advertising is a cooperative exercise; however advertising intended to be pulled by the consumers is currently complex and expensive to produce at this time. Advertising content producers and program content producers need to cooperate in the production.

Mechanisms have been proposed to facilitate accessibility of supplemental information that is associated with a corresponding media content presentation that address the drawbacks, limitations and/or shortcomings of the previously described conventional approaches. These mechanisms provide the viewer with an interface through which they can signal a location within the media content for which they would like to access supplemental information. The system accesses a data structure that contains the relationship between pieces of available supplemental information and locations within the content presentation, using the location signaled from the viewer to determine what supplemental information is available. An interface to navigate through the available supplemental information is provided. Some primary benefits over conventional approaches are that the media presentation is not modified to support the association of supplemental information, supplemental information may be added to the data structure at any time during or after the production of the media content, the addition of supplemental information may be performed at a very low cost, the supplemental information does not need to be distributed with the media content but is only retrieved by those interested in it.

These mechanisms do have a potential weakness though in that its very unobtrusive nature requires that the viewer will make requests for information without knowing if any is available. While the mechanisms have features to enable and encourage the association of supplemental information with media content presentations, the amount of supplemental information associated with any given program may be limited. If viewers repeatedly fail to find any associated supplemental information of interest to them a number of them will stop attempting to use the service, resulting in lost opportunities.

Furthermore, making requests to find associated supplemental information places a load on the system for delivering the associated supplemental information, including the user terminal portion and the shared portion. If requests for unavailable information can be avoided, the system resources can be preserved for accesses that will provide value.

Other systems exist outside of media content distribution in which supplemental information may be requested for an identifiable subset of a population of items. A television program could be considered to be a population of image frames plus audio—another system could be a population of patients with RFID identification bracelets. These other systems may have user terminals (e.g. handheld devices with an RFID reader and wireless access to a central database). When such user terminals accesses the central database for a member of the population encountered, this requires transactions which will load the database, the network used to communicate between the user terminal and the database, and the user terminal itself. If the user is only interested in accessing certain pieces of supplemental information that are only present for a fraction of the total population, then transactions which occur for members of the population that do not have supplemental information of interest waste resources.

Therefore, facilitating accessibility of supplemental information that is associated with a corresponding program content presentation in a manner that overcomes drawbacks, limitation and/or shortcomings of conventional approaches for facilitating accessibility of supplemental information that is associated with program content would be advantageous, desirable and useful.

### SUMMARY OF THE DISCLOSURE

Implementations of the present invention fulfil the need of providing an interactive approach for selection and display of supplemental information (e.g., advertisements) during presentation of user accessible content in a manner that is better suited to the preferences and desires of individual consumers (i.e., IPTV program content viewers). More specifically, such implementations allow the a consumer or user to select whether cues should be presented to them simultaneously with user accessible content indicating that there is supplemental information accessible corresponding to the point of the user accessible content, being currently viewed. In this manner, implementation of the present invention overcomes the drawbacks of the recently proposed mechanisms that only present supplemental information when the viewer requests it. That is, the risk that a viewer will repeatedly request supplemental information when it is not available and lose interest in the service.

To this end, it is an object of the present invention to provide a cost-effective, and effective way to provide immediate indications of the availability of advertising or other supplemental information to the viewer in accordance with the current location (e.g., time index) in the user accessible content that is being viewed. It is a further object that the viewer be able to customize what supplemental information these indications are presented to them for.

The present invention is applicable in other applications as well in which there may be information that can be accessed related to a point or an object that can be identified. Instead of a time index within a program, a digital identifier is used to select information for retrieval. An example could be retrieving information about an object or person identified by an RFID tag, which is well known functionality. The present invention provides a mechanism to reduce access to the database to retrieve information that is not available. Limitations on bandwidth, transaction latencies and power usage by mobile user terminals can be reduced or avoided through the use of the present invention.

In one embodiment of the present invention, a method for facilitating association of user accessible content with supplemental information that is at least one of audibly and visually outputted by a user terminal comprises a plurality of operations. An operation is performed for maintaining a data structure that associates supplemental information relating to the user accessible content with identifying information corresponding to the supplemental information. Prior to a location within the user accessible content where content corresponding to the supplemental information is contained being outputted via the user terminal, an operation is performed for receiving an identifying information query corresponding to the user accessible content from the user terminal. An operation is performed for transmitting the identifying information for reception by the user terminal in response to receiving the identifying information query and prior to the location within the user accessible content where content corresponding to the supplemental information is contained being outputted by the user terminal.

In another embodiment of the present invention, a system for facilitating association of user accessible information and supplemental information that is at least one of audibly and visually outputted comprises a table, a query processor, a consumer interface device and a sender. Maintained in the table is a data structure that associates supplemental information relating to the user accessible content with identifying information corresponding to the supplemental information. The identifying information dictates a timeframe during which a cue indicating accessibility of the supplemental information is to be simultaneously outputted with the user accessible content. The query processor is configured for receiving an identifying information query corresponding to the user accessible content. The consumer interface device is configured for transmitting the identifying information query for reception by the query processor prior to a location within the user accessible content where content corresponding to the supplemental information is contained being outputted. The sender is configured for transmitting the identifying information in response to the query processor receiving the identifying information query and prior to the location within the user accessible content where content corresponding to the supplemental information is contained being outputted.

In another embodiment of the present invention, a user terminal configured for facilitating access of supplemental information that is accessible via the user terminal and that is associated with user accessible content is further configured to perform functionality for allowing such facilitating access. The user terminal performs functionality causing an identifying information query corresponding to the user accessible content to be transmitted for reception by a supplemental information serving apparatus prior to a location within the user accessible content where content corresponding to the supplemental information is contained being outputted. Furthermore, the user terminal performs functionality causing identifying information to be received from the information serving apparatus in response to the information serving apparatus receiving the identifying information query and prior to the location within the user accessible content where content corresponding to the supplemental information is contained being outputted. Still further, the user terminal performs functionality causing a cue indicating that supplemental information associated with the user accessible content is available. The identifying information specifies a timeframe over which the cue is to be simultaneously outputted with the user accessible content.

As can and will be seen from the disclosures made herein, implementations of the present invention advantageously provide a new type of video advertising model, which benefits the consumer/viewers by providing them only with desired information, and benefits the advertisers of the products and services by focusing their messages on their target market. In this “pull type of advertising” model of the invention the advertiser operates in cooperation with the potential customer rather than inconveniencing the viewers in general.

Thus, through implementations of the present invention, the consumer is given immediate access to any available information pertaining to an ad and determines right away if further information is not available. Viewers do not have their program intruded on by advertising—on the other hand if they would like more information on something they see, it may be available. As “links” to a product/service of interest are inserted by the advertisers, the consumer does not need to access a separate search engine, determine the correct search terms, decide if returned hits are for the item of interest and then repeat this operations until either information on the item is found or the viewer ascertains that there is no information available. Still further, as advertising that is pointed to by “links” will be viewed only by customers interested in learning more about the product; it is not necessary to make special efforts to grab the attention of reluctant viewers.

Furthermore, through such implementations of the present invention, the consumer is given the capability to “bookmark” points in the user accessible content for which they would like to access supplemental information. At any time after this, the consumer may return to these points to determine what supplemental information is available at that time, which may be different from what was available at the original time of program viewing. The consumer may explicitly revisit the user accessible content point (which does not necessarily require viewing the point of the user accessible content itself) for the latest supplemental information, or the system may signal to the consumer when supplemental information relevant to the customer's bookmarked locations is updated.

From the advertisers point of view, the video advertising business method of the invention enables the advertisers to monitor the consumers following advertising links, which in turn allows a clear charging model, such as for example “pay per click” or other models. In addition, it allows the video program producers/developers to sell advertising links to product manufacturers. Advertising links may also be provided to the distributor (i.e. IPTV provider) and may then be sold to local merchants. Additionally, a further advantage of implementation of the present invention is that supplemental information relating to content can be kept up to date and localized (e.g., supplemental information displayed may be chosen based on customer location).

These and other objects, embodiments, advantages and/or distinctions of the present invention will become readily apparent upon further review of the following specification, associated drawings and appended claims.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates a block diagram of the system according to the invention;

FIG. 2 shows the block diagram of an embodiment of the query processor; and

FIG. 3 illustrates an example of how the supplemental information for a commercial is correlated with the user accessible content and with a consumer query.

### DETAILED DESCRIPTION OF THE DRAWING FIGURES

With recent advances in digital transmission technology, subscriber television systems are now capable of providing much more than the traditional analog broadcast video. In implementing enhanced programming, the home communication terminal known as the set-top box (STB), has become an important computing device for accessing content services and navigating a user through a maze of available services. In addition to supporting traditional analog broadcast video functionality, digital STBs now also support an increasing number of two-way digital services such as video-on-demand and personal video recording (PVR).

In this specification, “consumer” refers to persons (recipients) who may use the advertiser's commodity or service, and absorb the content of the ads. The term “advertisers” refers to entities that prepare material relating to various products and services, with a view to induce the consumers to buy, use, or further promote the respective products/services. The term “content provider” includes the promoters that initiate, develop, and generate, entertainment content (programming) attracting many of the consumers. The term “service provider” includes the promoters who distribute entertainment content (programming) to the consumers, and integrate within the programming commercials provided by the advertisers. A single role as identified by these terms may be addressed by more than one entity, and a single entity may play more than one of the roles identified by these terms.

The term “supplemental information links” refers to the information that is displayed on a consumer terminal (e.g., a STB) after a request to access supplemental information is made while watching the program. A consumer terminal is one example of a user terminal. A user terminal is refers to a terminal through which a user (e.g., a consumer) accesses electronic information. These links may be hierarchical e.g. indicating what subjects (e.g. information on actor, audio, vehicle, furniture, etc) have supplemental information available at point of the program currently being viewed. The supplemental information links may then be selected to access the actual supplemental information. It is also possible to provide a consumer with the link to a really simple syndication (RSS) feed, which is a family of web feed formats specified in XML and used for web syndication. Web feeds provide web content or summaries of web content together with links to the full versions of the content, and other metadata. RSS, in particular, delivers this information as an XML file called an RSS feed, webfeed, RSS stream, or RSS channel. In addition to facilitating syndication, web feeds allow a website's frequent readers to track updates on the site using an aggregator.

The specification uses the term “supplemental information” for the information related to a product, person or a service that is made available to a consumer, and which is directly associated to a program being viewed. This term broadly refers to any type of information available to the public or provided by advertisers regarding a respective product, person or service. Namely, it may include information not intended as explicitly promotional, similar to bonus features available on many DVDs, bibliographical material for various personalities, etc. The supplemental information may also include links to additional information that may be available to viewers.

It is disclosed herein that supplemental information broadly includes one or more supplemental information links. For example, after a request to access supplemental information is made while watching the program, non-selectable information (i.e., not a link) and a supplemental information link can be displayed (i.e., outputted). Thus a consumer can view such displayed supplemental information and/or select the supplemental information link thereby causing additional supplemental information to be outputted, causing additional supplemental information to be sent to an associated e-mail address (i.e., an e-mail address accessible by the consumer), causing additional supplemental information to be sent to an associated website (i.e., a website accessibly by the consumer), etc

For example, the supplemental information for a laptop shown within a certain program, could be the product type, model and the cost, and the supplemental information may include all technical parameters of the laptop, a tri-dimensional image, shipping and handling information, warranty information, etc. Or, the supplemental information for a performer (actor, athlete) may include the name and the most relevant appearances; with links to further information which may include biographical data, etc. and which may provide links to other programs featuring the performer. The supplemental information may include various levels of detail, e.g. simple identification, 30 second advertisement, 5-30 minute presentation, identification of local retailers, etc. that the viewer can select between. In some instances, the supplemental information may include one or more links to additional information obtainable over the World Wide Web. The extent of the supplemental information available for viewing depends on the information provided by the advertiser. This supplemental information can be edited at any time. If, in the example, the laptop shown is obsolete, basic information on it can be provided along with links to current models. Or if there is a special limited time offer for a product, this can be advertised during the time of the offer.

The program may include an indication if supplemental information is available for the current point of the program. This may be in the form of an on-screen icon, which may further provide some form of indication of what type of information is available

Finally, the term “broadcast network” refers to a network that connects the consumers with the entertainment content and the associated ads. The broadcast network can comprise TV, cable, streaming Internet, private networks, or any other mass media broadcast. The broadcast network can charge a subscription fee for consumers to receive the entertainment and advertising content broadcast via the network. The invention is also applicable to systems supporting video on demand (VOD), including IPTV systems. The invention can furthermore be implemented to support video distribution by other means, including pre-recorded media.

Currently, a service provider includes commercials within a programming with a view to promote the advertisers products/services, in exchange for agreed-upon compensation. The basic idea of the invention is to keep records for each piece of supplemental information as to what locations in the program the information is relevant for. The location is a temporal measurement, and the location in the program is a range capturing the start and end of relevance or equivalently start and duration or any equivalent. The location measurement may be linear, as in time from beginning or frame number or it may be non-linear such as chapter or scene number, or it may be a hybrid such as time from the beginning of a given chapter. The location may also take the form of the location in the media file that is being read out.

The preferred implementation of the invention makes use of pre-existing location measurements; however the addition of a new location measurement mechanism is also covered by the invention. When a consumer requests supplemental information for something present at a given point in the program, the location in the program that the request was made at is compared to these records to find all relevant supplemental information. These records enable consumers to get linked with the supplemental information available for the respective product, person or service. For example, if a consumer wishes to find more about a car that is involved in a race in a program (a movie), a simple click while the car is on screen will provide a selection of links to available supplemental information relevant to that point of the program, including the car. It will be fast and easy to select the appropriate link. The availability of supplemental information to the viewer depends on the current location in the program that is being viewed and selected.

Embodiments of the present invention can have certain prerequisites for implementation. One such prerequisite is having some sort of primary information that is presented to one or more persons (e.g., a video program, a population of objects or people, etc). Another such prerequisite is that there be some means of identifying specific portions of the content (e.g., timecode values for video, RFID tags, etc). Still another prerequisite is that there be some supplemental information that can be associated with the identified specific portions of the primary information and that supplemental information associated with different portions of the primary information can be on different subjects. For example, at various locations in a video program, there can be supplemental information available on a vehicle shown, on music played in the background, on an actor. Within a hospital, a given patient may have certain test results available that might not be performed on other patients. And in any condition there may be no supplemental information associated at all with a portion of the population. Yet another prerequisite is that there be a user terminal that can request supplemental information by sending the identifier of the specific portion to the system that stores the supplemental information.

As can be seen from the disclosures made herein, there are a number of advantageous and attributes that make implementation of the present invention desirable. One such attribute is that a user of a system in accordance with the present invention is only interested in a subset of the available supplemental information. Another such attribute is that there is a non-zero cost to distribute supplemental information to the user terminal (e.g., bandwidth, power consumption by user terminal, etc.). Still another such attribute is that identifying information as used in implementation of the present invention is smaller (i.e., requires less system resources to create, manage, interpret, and/or communicate) than associated supplemental information and can be efficiently and/or practically transmitted to user terminals. Timeframe information such as timecodes is one example such identifying information. The present invention is not limited to any particular type of identifying information. Thus, embodiments of the present invention can be implemented using other known and/or yet-to-be-conceived types of identifying information.

Thus, broadly speaking, in at least one implementations of the present invention, in conjunction with accessing primary information (e.g., video program content), a user terminal sends a request for identifying information for the portions of the primary information for which there is associated supplemental information. Preferably, such supplemental information is of particular interest to the user. In response, the identifying information is sent to the user terminal. Such identifying information can be ranges or lists of timecodes or other type of identifiers. Thereafter, as the user moves through the primary information (e.g., watches video program, scans different tags, etc.), the user terminal references the identifying information to determine if there is supplemental information of interest to the user available, this availability can be signaled to the user before the user terminal sends a request for supplemental information. Advantageously, the result is that the user doesn't need to query a database to find out there is no available information, thus saving latency, bandwidth, power, etc.

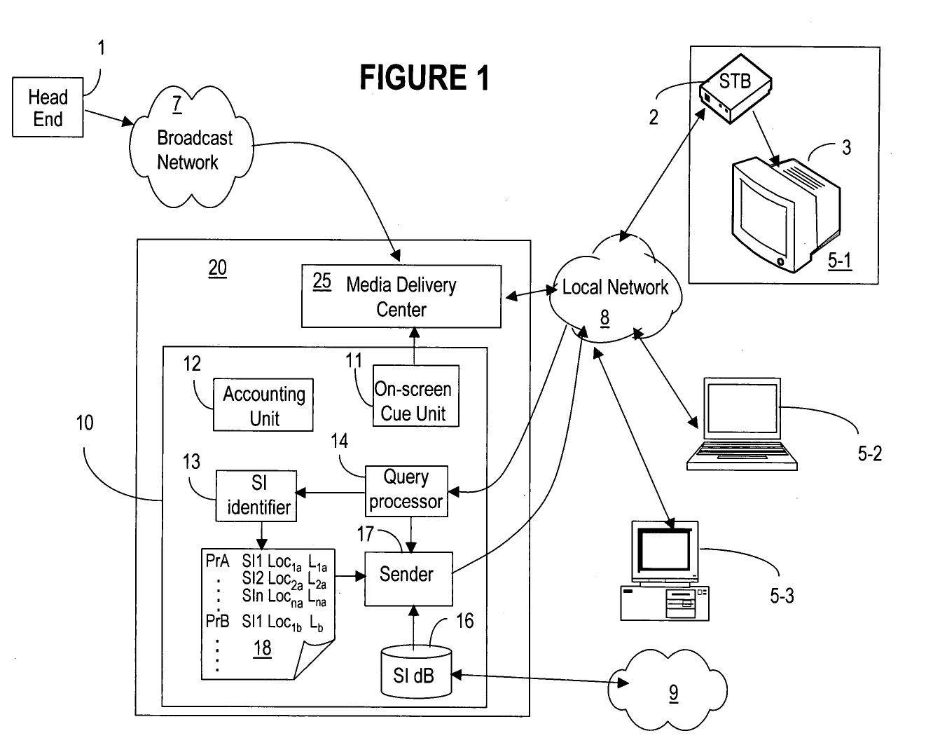

FIG. 1 illustrates a block diagram of the advertising with video programming system according to the invention. In the example of FIG. 1, the programming is provided from a head-end 1 to a local server 20 over a broadcast network 7. Local server 20 is equipped with a media delivery center 25 that performs the well-known functionality of such a center for delivering video content to subscribers/consumers over a local network 8. The type of networks 7 and 8 is irrelevant to the invention.

The example of FIG. 1 also shows three consumer terminals 5-1, 5-2, and 5-3, where terminal 5-1 comprises a set-top box (STB) 2 and a TV set 3, terminal 5-2 is a laptop and terminal 5-3 is a PC. It is evident that the number of terminals is not limited to three, that the particular type of terminal is irrelevant to the invention, as other types of video terminals may be connected over the local network 8 to enable play-back of the video content streamed from the local server 20. Terminals 5-1, 5-2 and 5-3 enable trick-play (pause/rewind/fast forward/etc. of the programming) so that the user may stop the program and record it with a view to see and research an ad associated with the program, and continue seeing the program later or to record parts of interest of the program for researching the embedded commercials later. These terminals also allow the “bookmarking” of points in the program to allow the access of associated supplemental information at a later time. This may include supplemental information that has been associated with the program point at a time (i.e. real time, not program time) after the initial viewing of the program.

According to the invention, a supplemental information (SI) unit 10 is provided at the local server 20, for enabling the users in the geographical area served by local server 20 to access the available supplemental information of interest. SI server 10 provides access to the supplementary information to terminals 5-1, 5-2 and 5-3 or a RSS feed (not shown) on request. It is evident that a plurality of SI units 10 may be provided throughout network 7 for serving various local communities; also, a SI unit 10 may be located at the head end 1. If the SI units 10 are centralized, subscriber location information may be included in queries to allow for localized commercials. As indicated above, this information may refer to products and services provided of global interest (e.g. cars, computers, movies) or by local companies (e.g. specific retailers).

In all the above variants, after programming is developed, the supplemental information is associated with specific points or particular sections in the programming that direct the consumer to sources of information. The term “SI location” refers to the point or section within the programs that, when the consumer clicks, returns a particular supplemental information link. SI unit 10 includes a link database 16 that stores the supplemental information, and a table 18 that provides the association between the SI locations and the supplemental information links to the respective supplemental information. The entries may in addition contain an indicator of the type of information provided and/or what it is relevant to. It is to be noted that while FIG. 1 shows a table 18, which maintains the SI locations for a number of programs, a table per program may equally to be used. Also, a program may be broken down into a number of “chapters” and a table 18 may exist for each chapter or other division or a single table 18 may maintain the SI locations for each chapter or other division.

Table 18 in FIG. 1 shows the SI locations for a program A (a movie) denoted with PrA with n different instances where supplemental information is available. As seen in this example, the first supplemental information SI₁ is available at a location denoted with Loc₁; as indicated above, this point indicates the temporal location within the program which may be measured in a number of ways, with a preference for already existing measurements, e.g. many video players are able to indicate the elapsed time (or remaining time) of the program. Regardless of the actual measurement used (which could also be frame number or location within media file), the measurement is equivalent to time from the start of the program, and as such will be referred to as a time measurement. The location measurement available may be dependent upon the program type and viewer implementation; however translation will be mathematically simple and may take place during the generation of table 18 for the particular implementation or when the queries are received. Links denoted on table 18 with L₁ to Lₙ provide the link to the actual supplemental information kept in SI database 16.

One aspect of location translation separate from the metric used to measure the location occurs if the program is subject to different versions. For instance, the program may be edited for content such as removing scenes that may be objectionable to certain audiences. Or content may be inserted, for example conventional advertisements may be inserted into a broadcast program, and if the customer terminal is not able to automatically recognize the presence of the advertisements it will measure location as if it were a single program. The insertion or deletion of a known amount of content, at known points in the program, allows straight-forward translation between locations in the edited program and the original program. The different versions of the program may be treated as different programs or a single table could be used with location translations used to compensate for deleted or added content.

In order to see/research a product/service, a consumer ‘clicks’ while a subject of interest is being presented (visually or audibly) in the program, using the channel selector or the mouse, etc. The click generates a query that arrives at a query processor 14 provided in the SI unit 10. In response to this action by the consumer, the consumer terminal (STB, PC, etc) or the SI unit, or both in cooperation determine the most recently viewed point of the program. FIG. 1 shows an embodiment where the query processor determines the program being viewed, the location of the query within the program (henceforth referred to as program time), and identifies the consumer terminal that generated the query.

The program time of the query, denoted with T_{Q} is used to identify entries in the table 18, as shown by a SI identifier unit 13. The SI unit 13 signals the location of the query within the program using the same metric as the entries in table 18. In any case, the SI location for that query is identified by unit 13 is used to determine which supplemental information links are available for the respective SI location. These are delivered to the consumer for selection. It is possible to have entries that match to any time index, i.e. they are relevant for the entire program. It is also possible to allow the consumer to send a query for supplemental information that is relevant for any point in the program, regardless of time index. This can be extended to allow the configuration of certain pieces of supplemental information to not be accessible by such a general query, for scenarios in which it is desired for the customer to view the program rather than only access the supplemental information. For instance, a training program could require access to supplemental links that can only be accessed while viewing the program in order to ensure the viewer watched the program. Or a contest could make use of supplemental links and it would not be possible to simply view all available links, it would be necessary to view the program.

A sender 17 is used to provide the link information to the consumers. Sender 17 is also used to deliver to the consumer terminal the supplementary data requested from the SI database 16. It is noted here that the supplemental information in database 16 may include additional links that direct the consumer to more detailed information, if of interest. This is generically shown by the network 9, which may be for example the Internet with its wealth of information, or may be a private network managed by the advertiser, etc. The extent of information provided in database 16 it at the discretion of the advertiser, as is the availability of any additional links. A further ability is for the SI accessed from the database 16 to provide a generic link, which provides links to specific advertisers that are relevant to the generic link. This allows multiple (potentially competing) advertisers to be accessed through a single entry in table 18. It also allows the connection between an advertiser or advertisers and content to be made without editing the entries in table 18 for each program.

The SI unit 10 may also be equipped with an accounting unit 12 that monitors use of commercials for establishing a revenue value for each program according to the usage of the supplemental information. The usage may be determined based on any charging model (e.g. pay per click, or per time, numbers of queries, downloading time, etc.). In the case of advertisements, the charges would tend to go to the advertisers, in the case of other supplemental information charges could apply to viewers, no charge access is also an option.

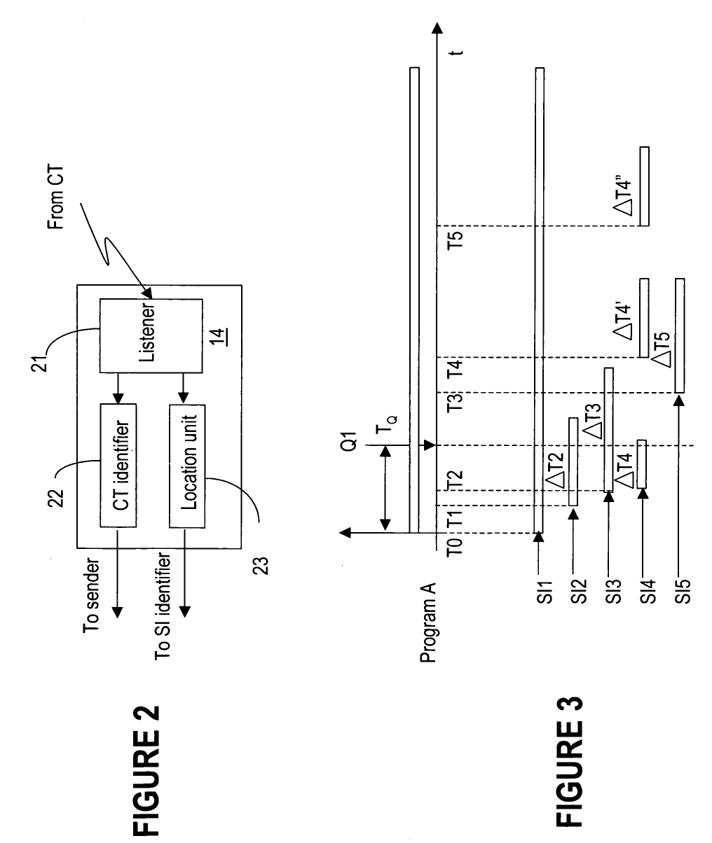

FIG. 2 illustrates the block diagram of an embodiment of the query processor 14. The query processor includes a listener 21 for detecting all queries generated by the consumer terminals 5-1 to 5-3, a consumer terminal identifier 22 that associates the query with the terminal that generated it, and a location unit 23. Location unit 23 identifies the associated program and location in the program of the respective query, which is provided to the SI identifier unit 13, for enabling it to determine the correct entry into table 18. The location may be determined solely based on information in the query from the CT. Alternatively, the location may be determined based on combined information in the query and information available in the local server. This server based information may include information on program playback from the Media Delivery Center 25. The information may also include information required to translate the location from the format in the query to the format used in table 18.

Other embodiments of the SI unit 10 are possible. For example, STB 2 provides the time-mark in the program of the query. Another variant is for the query processor 14 may send the link to the media delivery center for transmission to the terminal, and use a programming sender for delivery of the supplemental information, in which case sender 17 is not needed. Also, the query may be detected by the media delivery center 20, which is customary equipped with an interactive program guide unit (not shown); in this case, the media delivery center 20 identifies the queries as being related to requests for supplemental information, and provides the time of arrival information directly to SI identifier 13. In all variants, SI unit 13 identifies the relevant entries in table 18 based on the time of the query relative to the beginning of the program, or relative to some known part of the program.

It is also possible to configure the consumer terminal (STB or other implementation) to provide on screen cues when supplemental information is available. In the example of FIG. 1, an on-screen cue unit 11 is used for inserting cues indicating to the consumer that the respective view enables obtaining of supplemental information. The cues may be just a simple mark, or may be more complex cue in that it may provide specifics on the type of SI available (e.g. a commercial, or biographic data), etc. Alternatively, the program may have on screen cues inserted at the media delivery center. A further alternative is to add on screen cues to programs stored at the local server or elsewhere in the network. Changes in the supplemental information would require modification to the stored version with the on screen cues.

The example of FIG. 3 shows the how the supplemental information is associated with a program PrA, which includes links to SI₁ to SI₅, with the relevance marked relatively to the start of the program PrA, which is time T0. Please note that the time is one of the ways the correlation between the supplement information and the program can be made. As indicated above, the frame number may equally be used, or any other way of marking the point/section in the program which is associated with SI. It is also possible to enable the consumers to access the same supplemental information at multiple points during a program. As an alternative to the time window ΔT, the end point of the window may be stored.

In the examples shown in FIG. 3, supplemental information SI₁ is associated to the entire program A, from T0 to the end of the program. For example, if the program is a movie, the link L₁ associated with SI₁ directs the consumers to general information about the movie, such as the cast, director, award, rating, etc., whenever he/she clicks on any scene during the movie playback. Let's further assume that SI₂ provides information about some cars (make, year, etc), and the SI location identifies a sequence extending from T1 for a relevant time of ΔT2; the consumer shows interest in the cars participating in the race by clicking during ΔT1, the link L₂ leading to the actual SI₂ which will be returned to the consumer. Further, availability of supplemental information SI₃ extends over a sequence of length ΔT3 starting at T2, and may for example provide a link L₃ to information about a certain museum shown in that sequence. As seen for example in the case of S14, the supplemental information is available at three instances (T2, T4 and T5) during the course of program A, each extending over a different time range for each instance, here ΔT4, ΔT4′ and ΔT4″. The actual table implementation may for this case have three entries, each with the same link, or the table may allow the association of more than one location with a given entry.

FIG. 3 also illustrates how the information associated with a certain commercial is correlated with the time T_{q} when a consumer query is received at SI unit 10. If the time of arrival of query Q1 is T_{Q} after the beginning of the program PrA, SI unit 13 accesses table 18 and determines which entries are relevant at time T_{Q}. This results in L₁, L₂, L₃ and L₄ being returned to the requestor. These links are sent to the consumer terminal that issued the query, using sender 17. Once the consumer receives the links, he/she may select which if any of the links are of interest for further investigation. The link(s) of interest may be stored and the program may be resumed, or viewing of the program may be suspended while the consumer follows the link. Also, the location within the program of the query may be stored and the program resumed. Supplemental information for the query location may be reviewed and investigated at a later time, at which more information may be available.

In the embodiment described above, the consumer clicks on an image with an expectation to get information about a product/service. If no commercial or information is available for the respective sequence playing back on the consumer's display, the consumer may be given the option of bookmarking the location. The process of bookmarking may involve the sending of a permanent (direct) location value to the CT, in case the program is subject to multiple versions. It is possible to configure the consumer terminal (STB, PC) to display on-screen cues when supplemental information is available, by using the on-screen cue unit 11, as discussed above in connection with FIG. 1.

Implementation of the present invention enable a large number of products/services to be “advertised” simultaneously—ultimately almost anything on the screen, anything being heard (i.e. music track) or discussed. Still further, this mechanism may be used to access non-program related advertising, in which a supplemental information link may allow connections to advertising not related to the program being viewed. This is particularly suited to local advertising (e.g. “Hmmm, I'm hungry, what are my choices?”). While this is similar in effect to accessing a web browser to search for information on the web, it does not require the consumer to use a different interface.

Metadata transmitted with the program content is only used by the consumer terminal when the program is being viewed live. If the program is being viewed from a PVR or on demand, then the synchronization problem identified will not occur and the most up to date information can be fetched (i.e., independently access and retrieved). If a PVR is being used to provide trick-play functionality (e.g. pause, rewind) for a program otherwise being viewed from the broadcast, then the broadcast events can be used unless the viewing point is delayed more than some threshold value relative to the broadcast point. If the broadcast is of a live event that can have metadata added shortly after occurrences within the event, a preferred solution is to replace presence/absence indicators (e.g., start-stop times) with some indication that the broadcast is live (and metadata is expected to be added soon). If the program is viewed (e.g. from a PVR) after the live event has concluded, then the metadata event timing (i.e., timing information) can be retrieved in the same way as for a program that was not live when broadcast.

The behavior when conventional advertisements (or news updates or other items) are inserted during a program is subject to some alternatives based on how frame identification takes place. The program and any insertions may have use a contiguous numbering scheme to identify frames, in which case the user terminal will see it as a single program. However the program and insertion behavior will have to be known in a frame accurate (or nearly so) way before broadcast. Customization of inserted content adds complexity. This can be addressed if behavior can be predicted.

Alternatively, the program and any insertions will have independent frame identifiers, and will appear to the user terminal as different programs. For this alternative, the frame identification consists of more than an indicator of time (e.g. from start of program or time of day of broadcast), rather it must include an identifier of the program being viewed—and a different identifier will be used for the primary program and for each insertion. The invention includes the function to retain the primary program metadata timing events during display of inserted ad content (with its own events). The program identifier for inserted content may have a characteristic that the user terminal can recognize, indicating that the content is an insertion. Alternatively, the user terminal could recognize that it has metadata timing events for frames of the primary program that it has not seen yet. In such situations, the event set will not be discarded while any insertions are being viewed. Metadata event timing for the insertions may be broadcast with the insertion. Metadata that applies to the entire program will not trigger the same on-screen cue as metadata that only applies to specific parts of the program. It may either have a separate cue or none at all.

Advantageously, the present invention allows a viewer to configured their STB to provide on-screen cues for any supplemental information or for specific classes of supplemental information. In such case, the STB will automatically query the database for start-finish times (i.e., timeframe information) for available supplemental information. More specifically, the STB will automatically query the database for the start-finish times for the aggregate of supplemental information that the viewer has specified rather than for individual pieces of supplemental information. Once the STB receives the start-finish times, it can compare the location (e.g. timecode) within the program being watched to these times and insert cues accordingly.

It is disclosed herein that start-finish times refer to when there is something on the screen (or audio information) for which there is associated supplemental information available. Advantageously, the actual supplemental information itself is independent of the program being viewed so with a suitably flexible interface any of the supplemental information can be accessed at any time.

### EXAMPLE 1

### Supplemental Information in Combination with a PVR Recorded Program

A viewer (i.e., consumer) has recorded an episode of a particular show (i.e., program content) on their STB (i.e., consumer terminal) using which PVR functionality of their STB. The next day the viewer starts to watch the show. The viewer has previously configured the STB to show on-screen cues whenever there is supplemental information on ‘gadgets’ in the program (i.e., consumer-specific criteria). When the viewer begins to watch the show using the STB, the STB sends a request (i.e., timeframe information request) to a database for retrieving start-finish times (i.e., timeframe information) for supplemental information on “gadgets” for the episode of the particular program. The database returns a list of start-finish times corresponding to when there is supplemental information on “gadgets” available within the program. The list is a filtered set of timeframe information dependent on the consumer-specific criteria. As the STB is playing back the show, on-screen cues indicating available supplemental information pertaining to gadgets are displayed when the playback point of the program is between the start-finish times received.

If the viewer presses a “more information button” while an on-screen cue is present, they can expect that supplemental information will be available for one or more gadgets that are currently on the screen. There can be information available on other things such as characters, furniture, etc. etc, which they can access by reconfiguring the STB or appropriate on-screen selection for supplemental information not within their configured criteria). It is disclosed herein that the STB can be further configured to allow access to a menu of supplemental information that opens up to a level corresponding to the viewer's preference (e.g. gadgets), though the viewer can still navigate to select other categories of information.

### EXAMPLE 2

### Supplemental Information while Viewing of an On-Demand Program

A viewer is watching a streaming broadcast program as it is being broadcast on a channel. It is disclosed herein that the on-demand broadcast many be subject to minimal delay through a PVR. The viewer starts to watch the broadcast program just before or as the program is starting. They have configured their STB to show on-screen cues as in Example 1 above. Embedded in the signal carrying the broadcast program is timeframe information indicating the start-finish times for available supplemental information. The timeframe information can be sent before the corresponding points in the broadcast program or optionally it can be sent at the start or a short time before the corresponding points in the broadcast program. As the show is being watched, on-screen cues are displayed when the playback point of the program is between the start-finish times received.

A further extension of the present invention is to provide automatic or semi-automatic configuration changing. That is, if the viewer tries to access information and there is none available (e.g., after some number of times), the viewer would be asked if they want on-screen notification when such information becomes available in a program being viewed or listened to. To this end, viewer-specific criteria for supplemental information that is of interest to the viewer can be modified to include a category that includes the subject matter that the viewer was trying to access.

It is disclosed herein that the present invention can be broadly applied to user accessible content other than which is typically accessible via IPTV. More specifically, user accessible content in the context of the present invention can be any media or information deliverable via a user terminal and, correspondingly, such user accessible content is primary information with respect to supplemental information associated with such user accessible content. In addition to typical TV program content, examples of user accessible content and associated supplemental information in the context of the present invention include, but are not limited to, a train route and supplemental information relating to depots/stops along the train route, a voting ballot and supplemental information relating to candidates and/or propositions, an electronic vehicle brochure and supplemental information relating to vehicle features and/or special offers, a tradeshow vendor presentation and supplemental information relating to the vendor, a population of medical patients with identifying bracelets that have information related to their individual conditions and treatments, etc. The present invention is not unduly limited to any particular form or type of user accessible content.

It is also disclosed herein that delivery of content and communication of information can be facilitated by other known means besides IPTV. Thus, the present invention is not unnecessarily limited to a particular type of content or a particular type of infrastructure or protocol for delivering content or communicating associated information.

Another consideration with respect to the present invention is when the user terminal should request the information. There are at least two triggering mechanisms that the invention makes use of—a time based trigger mechanism and an event based trigger mechanism. Events can be viewer initiated or be present in the video stream (i.e., data stream representing the content being outputted). If the viewer has configured the terminal to not display on-screen prompts, then the events will not be requested at all. When the user changes the program being viewed, the functionality in accordance with the present invention can trigger the recovery of metadata events after some delay. This delay is to address the possibility that the viewer is “channel surfing”, visiting a number of channels for a short time each, looking for something to catch their interest. It does not seem productive to fetch information on a program that the viewer is about to stop watching. The delay can be fixed, or configurable by the viewer or can vary depending on viewer behavior. For example, the delay following one channel change can be short and, if the channel is changed multiple times within a given period, the delay can increase. Recognizing that channel surfing can frequently result in the viewer returning to the program initially being watched, implementation in accordance with the present invention can be configured to simultaneously store metadata events for more than one program. For instance, once a viewer has watched a given program for some threshold period, the metadata events will be kept in the system at least until some other threshold period has passed with a different program being watched or, for example, until the first program has ended.

When a viewer requests metadata associated with a program point being viewed, the recovery of metadata events for the entire program will be triggered (i.e., initiated), if the user terminal does not already have the metadata events for the program. Optionally, there can be a consideration of how old the metadata events are that the user terminal has—for live events, considerable metadata can be added during the program. When a program being viewed ends and a new program starts, the recovery of metadata events for the entire program can be initiated. Start and stop points for a program can be determined by the STB based on program information embedded in or accompanying the data stream representing the content being viewed. Alternatively, it can also come from a frame identification mechanism.

In the event of broadcast content on a particular channel, there will be simultaneous requests from all viewers of that particular channel. If different channels (e.g., video channels) are more or less synchronized as they are today (i.e., programs tend to start/end at the hour or half-hour), then requests for start-stop times will be triggered from all or nearly viewers. A means to mitigate too many simultaneous requests is to implement a random delay before the sending of the request. Accordingly, in this way, the level of synchronization will be reduced thereby reducing bandwidth and processing requirements. An alternative mechanism for providing start-stop times to an STB is to embed the timing information (i.e., metadata) in the broadcast stream using well-known methods to carry metadata. This can be either for the entire program (i.e. transmit all the events in as short a time as practical) or may be transmitted at closer to real time (i.e. events are transmitted shortly before they occur in the program). This is differentiated from existing transmission of metadata in that it only signals presence/absence of supplemental information and it is automatically generated based on the database contents.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for facilitating association of user accessible content with supplemental information that is at least one of audibly and visually outputted by a user terminal, comprising during an instance of said facilitating:
maintaining a data structure that associates supplemental information relating to said user accessible content with identifying information corresponding to said supplemental information;
receiving an identifying information query corresponding to said user accessible content from the user terminal prior to a location within said user accessible content where content corresponding to said supplemental information is contained being outputted via the user terminal; and
transmitting said identifying information for reception by the user terminal in response to receiving the identifying information query and prior to the location within said user accessible content where content corresponding to said supplemental information is contained being outputted by the user terminal.

2. The method of claim 1, further comprising:
accessing consumer-specific criteria defining supplemental information of interest to the consumer;
filtering a collection of available supplemental information instances dependent upon said consumer-specific criteria whereby supplemental information corresponding to said of consumer-specific criteria is identified; and
identifying said identifying information dependent upon said supplemental information corresponding to said of consumer-specific criteria.

3. The method of claim 1, further comprising:
outputting a cue indicating that supplemental information associated with said content is available, wherein said outputting includes assessing said identifying information for determining a timeframe over which the cue is to be simultaneously outputted with said user accessible content.

4. The method of claim 3 wherein the cue is one of a visual cue and an audio cue.

5. The method of claim 3, further comprising:
transmitting a supplemental information link for reception by the user terminal in response to a supplemental information request being issued from the user terminal while the cue is being outputted; and
outputting the supplemental information link in response to receiving the supplemental information link, wherein the supplemental information link is selectable to allow portions of said supplemental information to be accessed.

6. The method of claim 4, further comprising:
accessing consumer-specific criteria defining supplemental information of interest to the consumer;
filtering a collection of available supplemental information instances dependent upon said consumer-specific criteria whereby supplemental information corresponding to said of consumer-specific criteria is identified; and
identifying said identifying information dependent upon said supplemental information corresponding to said of consumer-specific criteria.

7. The method of claim 3 wherein said identifying information includes information designating the location of said supplemental information within said user accessible content, said location designating information includes a starting time indicating when the cue is to begin being simultaneously outputted with said user accessible content and a time range indicating for how a duration of time over which the cue is to be simultaneously outputted with said user accessible content.

8. The method of claim 3 wherein said identifying information includes information designating the location of said supplemental information within said user accessible content, said location designating information includes a starting time indicating when the cue is to begin being simultaneously outputted with said user accessible content and an end time indicating when said simultaneous output of the cue is to end.

9. The method of claim 1 wherein:
said user accessible content is at least one of audibly and visually outputted by the user terminal; and
said identifying information is transmitted independently of said content being outputted.

10. A system for facilitating association of user accessible content with supplemental information that is at least one of audibly and visually outputted, comprising during an instance of said facilitating:
a data structure that associates supplemental information relating to said user accessible content with identifying information corresponding to said supplemental information, wherein said identifying information dictates a timeframe during which a cue indicating accessibility of said supplemental information is to be simultaneously outputted with said user accessible content;
a query processor configured for receiving an identifying information query corresponding to said user accessible content;
a consumer interface device configured for transmitting the identifying information query for reception by the query processor prior to a location within said user accessible content where content corresponding to said supplemental information is contained being outputted; and
a sender configured for transmitting said identifying information in response to the query processor receiving the identifying information query and prior to the location within said user accessible content where content corresponding to said supplemental information is contained being outputted.

11. The system of claim 10 wherein the consumer interface device is configured for outputting a cue indicating that supplemental information associated with said content is available, wherein said outputting includes assessing said identifying information for determining a timeframe over which the cue is to be simultaneously outputted with said user accessible content.

12. The system of claim 11 wherein the cue is one of a visual cue and an audio cue.

13. The system of claim 11 wherein:
the sender is configured for transmitting a supplemental information link for reception by the user terminal in response to a supplemental information request being issued from the user terminal while the cue is being outputted; and
the user interface device is configured for outputting the supplemental information link in response to receiving the supplemental information link, wherein the supplemental information link is selectable to allow portions of said supplemental information to be accessed.

14. The system of claim 10 wherein the query processor is configured for:
accessing consumer-specific criteria defining supplemental information of interest to the consumer;
filtering a collection of available supplemental information instances dependent upon said consumer-specific criteria whereby supplemental information corresponding to said of consumer-specific criteria is identified; and
identifying said identifying information dependent upon said supplemental information corresponding to said of consumer-specific criteria.

15. The system of claim 11 wherein said identifying information includes information designating the location of said supplemental information within said user accessible content, said location designating information includes a starting time indicating when the cue is to begin being simultaneously outputted with said user accessible content and a time range indicating for how a duration of time over which the cue is to be simultaneously outputted with said user accessible content.

16. The system of claim 11 wherein said identifying information includes information designating the location of said supplemental information within said user accessible content, said location designating information includes a starting time indicating when the cue is to begin being simultaneously outputted with said user accessible content and an end time indicating when said simultaneous output of the cue is to end.

17. The system of claim 10 wherein:
said user accessible content is at least one of audibly and visually outputted by the user terminal; and
the sender is configured to transmit said identifying information independently of said content being outputted.

18. A user terminal configured for facilitating access of supplemental information that is accessible via the user terminal and that is associated with user accessible content, said user terminal being further configured during an instance of said facilitating to:
transmit an identifying information query corresponding to said user accessible content for reception by a supplemental information serving apparatus prior to a location within said user accessible content where content corresponding to said supplemental information is contained being outputted;
receive identifying information from the information serving apparatus in response to said information serving apparatus receiving the timeframe information query and prior to the location within said user accessible content where content corresponding to said supplemental information is contained being outputted; and
output a cue indicating that supplemental information associated with said content is available, wherein said identifying information specifies a timeframe over which the cue is to be simultaneously outputted with said user accessible content.

19. The user terminal of claim 18 wherein the cue is one of a visual cue and an audio cue.

20. The user terminal of claim 19 being further configured to:
receive a supplemental information link for reception by the user terminal in response to a supplemental information request being issued from the user terminal while the cue is being outputted; and
outputting the supplemental information link in response to receiving the supplemental information link, wherein the supplemental information link is selectable to allow portions of said supplemental information to be accessed.
